(19) United States
(12) Patent Application Publication
(10) Pub. No.: US 2005/0049163 A1
(43) Pub. Date: Mar. 3, 2005

(54) Dry-cleaning processes and components therefor

(76) Inventors: Fatemeh H. Akbarian, San Ramon, CA (US); William P. Sibert, San Ramon, CA (US); Helga M. Snodgrass, Walnut Creek, CA (US); Gregory Van Buskirk, Danville, CA (US)

Correspondence Address: Ray K. Shahani, Esq.;Twin Oaks Office Plaza, Suite 112, 477-Ninth Avenue, San Mateo, CA, 94402-1854, US

(21) Appl. No.: 10/897,623

(22) Filed: Jul. 23, 2004

Related U.S. Application Data
(62) Division of application No. 09/620,892, filed on Jul. 21, 2000.
(60) Provisional application No. 60/145,459, filed on Jul. 23, 1999.

(51) Int. Cl. C11D 17/00

(52) U.S. Cl. 510/285; 8/147

(57) ABSTRACT

A dispensable fluid pre-treatment composition for use in dry-cleaning of textile article processes comprising about 0.01-5.0% each of one or more surfactants selected from the group consisting of anionic surfactants and nonionic surfactants, about 0.01-2.0% amine oxide, about 0.0-1.0% preservative, about 0.01-4.0% alkali metal borate, about 50.0-99.99% fluid solvent, and dispenser for controllably dispensing the composition onto a textile article.

### RELATED APPLICATIONS

This Application is a Divisional of U.S. Ser. No. 09/620,892 filed Jul. 21, 2000 entitled DRY-Cleaning PROCESS AND COMPONENTS THEREFOR, which was related to and claimed benefit of priority of filing of U.S. Provisional Application Ser. No. 60/145,459 filed Jul. 23, 1999 entitled DRY CLEANING PROCESSES AND COMPONENTS THEREFOR, and claims any and all benefits to which it is entitled therefrom.

### FIELD OF THE INVENTION

The present invention relates to components for and processes concerning the dry-cleaning of textiles and garments that are especially adapted for non-commercial use.

### BACKGROUND OF THE INVENTION

Classically, the term “dry-cleaning” has been used to refer to processes involving the cleaning of textiles through the use of non-aqueous solvents. In fact, cleaning with solvents has been known for some time, having been first recorded in the United Kingdom as early as the 1860's. Dry-cleaning processes find greatest applicability for textiles such as linens, rayons, woolens and silks, that are subject to shrinkage in aqueous laundering processes. Moreover, dry-cleaning is also favored where garments are determined to be too valuable or too delicate to be subjected to aqueous laundering techniques. Various hydrocarbon and halocarbon solvents have traditionally been used in dry-cleaning processes, but the need to handle and reclaim such solvents has primarily restricted the practice of conventional dry-cleaning to commercial establishments. Further, such solvents of late have encountered increasing criticism due to environmental concerns.

While solvent-based dry-cleaning processes are quite effective for removing oily soils and stains, they are not optimal for removing certain particulate matter such as clay soils, nor are they particularly effective at removing proteinaceous stains, which may require specialized treatments. Conventional techniques for the removal of particulates and proteinaceous stains involve the use of detersive ingredients and operating conditions which are more akin to aqueous laundering processes than to conventional dry-cleaning.

In general, fabric cleaning and refreshment processes such as laundering and dry-cleaning are used to clean entire garments. However, in some circumstances, it may be desirable to clean portions of a larger garment, or only localized areas of fabric. Alternatively, it may be desirable to spot-clean a stain in a localized region before subjecting the entire garment to an overall dry-cleaning or laundering process.

In addition to the cleaning function, dry-cleaning also provides important “refreshment” benefits. So-called non-commercial dry-cleaning kits which freshen and/or spot-clean soiled fabrics have been described in the prior art, and commercial products are appearing with increasing frequency in the consumer market. These non-commercial dry-cleaning products remove undesirable odors and extraneous matter such as hair and lint from textiles. The use of such products is targeted to reduce the number of visits a consumer must make to commercial dry-cleaning establishments in those instances where garments may be only lightly soiled or malodorous.

One method for dry-cleaning fabrics in a laundry dryer is disclosed in EP 0 429 172A1 by Leigh, et al., which involves the placing of fabrics into a flexible container, such as a bag, along with one or more flexible treated substrate articles. The fabrics and treated substrate article are then tumbled together inside the flexible container in a laundry dryer, after which the container is opened and the fabrics are removed. Another method for treating fabrics in a laundry dryer is disclosed by Smith, et al., in U.S. Pat. No. 5,238,587. Smith discloses a fabric cleaning article for use with a home dry-cleaning kit comprising a porous substrate sheet impregnated with a gelled cleaning composition. The gelled cleaning composition consists of water, a gelling agent, an organic solvent, and a surfactant. Yet another home dry-cleaning composition intended for use in contacting garments in conjunction with domestic clothes dryers is disclosed by Sidoti, et al., U.S. Pat. No 5,865,851. The compositions of Sidoti, et al., comprise water, a nonionic surfactant, an anionic surfactant selected from among sulfosuccinates and sulfosuccinamates as well as salt forms thereof; and an organic solvent. Thickeners and gelling agents are mentioned as possible adjuvants. One disadvantage of the Sidoti formulations is that the cleaning compositions require two different surfactants in addition to an organic solvent. Furthermore, the formulation is intended to provide effective cleaning while featuring substantial thickening at levels of 92.5% water. Yet further compositions for treating garments in home dry-cleaning processes are disclosed by Siklosi, et al., in U.S. Pat. Nos. 5,547,476 and 5,632,780, which teach an aqueous system comprising two or more solvents. Other compositions for the treatment of garments in home dry-cleaning processes are taught by Roetker in U.S. Pat. Nos. 5,591,236 and 5,630,847; and Siklosi in 5,547,476.

One disadvantage of several of the prior art techniques is that the cleaning compositions require thickeners and/or gelling agents that may or may not contribute to the cleaning efficacy of the formulations. An additional disadvantage of many of the prior art compositions is the fact that residual powders or particles may be left behind on or entrained in the articles or garments with which they have been contacted. Finally, another disadvantage of the several prior art dry-cleaning techniques is that the pre-treatment process may result in incomplete removal of the stain(s), and/or the formation of “rings” or other unsightly residues on the fabrics.

None of the prior art references teach the use of a cleaning composition for non-commercial dry-cleaning purposes that obviates the need for extraneous thickeners or gelling agents. In addition, none of the prior art techniques for non-commercial dry-cleaning feature compositions that leave no visible residues either in or on the surface of the articles being refreshed and/or cleaned. Moreover, none of the prior art techniques for in-home dry-cleaning provide a containment bag that has high heat resistance, maintains its flexibility and provides acceptable hand-feel to the consumer with repeated usage.

### ADVANTAGES AND SUMMARY OF THE INVENTION

The present invention relates to heat-activated cleaning compositions and methods for the removal of stains, soils and malodors from fabrics and/or related garments. The present invention anticipates the use of cleaning compositions in conjunction with some type of warming or heat source, or a home heat-generating device. By way of example, it is contemplated that the cleaning processes of the present invention will typically and most generally be employed in conjunction with the use of a rotary clothes-type dryer. However, certain components of the present invention, such as the pre-treatment compositions and the absorbent pads, may find utility for removing localized stains or soils without subsequently causing the entire garment to be heat treated.

Although the following discussions will be mainly directed towards the use of a home rotary dryer, it will be understood by those knowledgeable in the relevant area that any of the components of the present invention may be appropriate for use either alone, i.e., without exposure to a rotary dryer, or through exposure to some other heat source such as a hot air gun, hair blower, heat fan, microwave oven, the sun, etc.

According to one embodiment of the present invention, a process for the dry-cleaning of a garment or other textile article comprises:
(a) optionally pre-treating a textile containing a localized area of stain by subjecting it to a fluid pre-treatment composition in combination with an absorbent stain receiving medium; and
(b) heat treating a textile that has been optionally pre-treated according to step (a) together with an activator cloth containing an activator solution into a flexible, sealable containment means.

In a preferred embodiment, the fluid pre-treatment composition for use in dry-cleaning textile article processes is non-thickened and comprises about 0.01-2.0% each of one or more anionic surfactant(s), about 0.01-5.0% each of one or more nonionic surfactant(s), about 0.01-2.0% amine oxide, about 0.0-1.0% preservative, about 0.01-4.0% sodium borate, and about 50.0-99.99% one or more fluid solvent(s).

As stated above, the heat treatment procedure will typically involve tumbling the sealable pouch or bag 110 and its contents at elevated temperatures in a home rotary-type clothes dryer. The various components for use with the dry-cleaning process will now be discussed in greater detail.

It is therefore an object and an advantage of the present invention to provide a composition for non-commercial dry-cleaning that avoids the need for thickeners or gelling agents.

It is also an object and an advantage of the present invention to provide a composition for the non-commercial spot dry-cleaning of fabric, which composition effectively cleans a localized region without leaving behind unsightly residues or “rings” on the fabric.

It is yet a further object and advantage of the present invention to provide a composition for the non-commercial dry-cleaning of garments or other articles that leaves behind no residues or build-up of materials either in or on the surface of the articles being refreshed and/or cleaned.

It is further an object and an advantage of the present invention to provide a composition for the non-commercial dry-cleaning of garments or other articles which does not discolor treated garments upon exposure to high temperature heating conditions.

It is also a further object and advantage of the present invention to provide an improved containment bag for non-commercial dry-cleaning which bag exhibits high heat resistance, yet improved flexibility and hand-feel, even with repeated usage.

It is yet a still further object and advantage of the present invention to provide an activator solution which provides the refreshing or cleaning of fabric articles while minimizing wrinkling.

It is still further an object and advantage of the present invention to provide a surfactantless activator solution for the cleaning and/or refreshing of articles in a non-commercial dry-cleaning process.

It is yet another object and another advantage of the present invention to provide a borate-containing pre-treatment fluid for use in an application in which no wash-out is required.

It is yet another object and another advantage of the present invention to provide an activator cloth loaded with a minimal amount of activator solution, thereby reducing wrinkling and minimizing the unnecessary use of volatile, potentially harmful vapors and/or other chemicals.

Further objects and advantages of the present invention will be come apparent through the following descriptions, and will be included and incorporated herein.

### BRIEF DESCRIPTION OF THE DRAWING

FIG. 1 is a representative schematic view of a preferred embodiment of the dry cleaning kit 100 of the present invention.

### DETAILED DESCRIPTION OF THE PREFERRED EMBODIMENT

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

It will be understood that in the event parts of different embodiments have similar functions or uses, they may have been given similar or identical reference numerals and descriptions. It will be understood that such duplication of reference numerals is intended solely for efficiency and ease of understanding the present invention, and are not to be construed as limiting in any way, or as implying that the various embodiments themselves are identical.

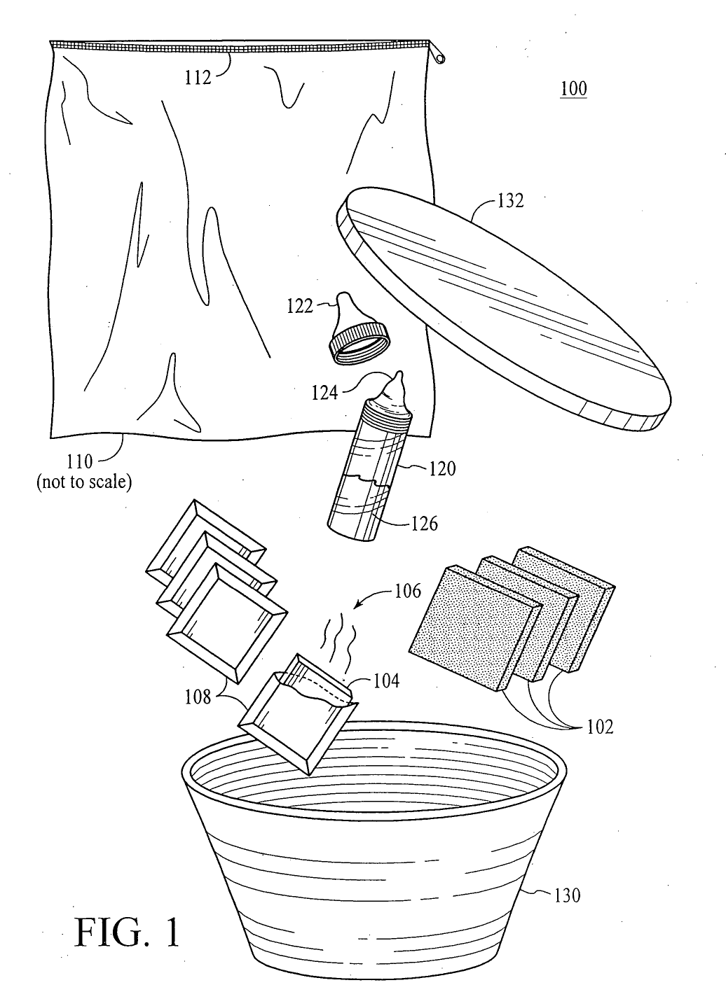

FIG. 1 is a representative schematic view of a preferred embodiment of the dry cleaning kit 100 of the present invention. In a preferred embodiment, the kit 100 comprises one or more portions of a predetermined dimension of absorbent stain removal medium 102 for absorbing the stain partitioned from the article to be cleaned. An activator cloth 104 or other absorptive substrate is impregnated, soaked or otherwise loaded with a volatile or other liquid activator solution 106 (shown as a vapor for illustrative purposes) for partitioning the stain from the article to be cleaned. Individual activator cloths 104 are sealed within a foil packet or other containment device 108 such as used for pre-moistened, individual towelettes. A specialized laundry-type bag or containment system 110, shown relatively smaller than would be required, is sized to contain the textile article or articles to be cleaned (not shown), the absorbent stain removal medium 102, and the activator cloth 104, all within the dryer (not shown). A closure means 112 such as mating pieces of hook and loop material at one end of the containment bag 110 seal or close the containment bag 110 as desired. Optionally, the kit 100 also comprises a plastic bottle 120 with a sealing cap 122 over a dropper or other type distal tip 124 to controllably dispense a pre-treatment stain formula 126 for pre-treating spots prior to cleaning. For distribution of the kit 100 to consumers or for storage, it will be useful to provide a specialized receptacle 130 with removable lid or cover 132. It will be apparent to those skilled in the art, therefore, that essentially any combination of the above items can be packaged or distributed together, all individually and in combination included within the scope of this invention, and only some of the most preferred shown in FIG. 1.

### Stain-Receiving Medium

One of the first steps in the dry-cleaning process for fabrics or garments is to inspect the item for regions of limited or localized soiling or stains. As heat treatment is known to set stains and make them more difficult to remove during subsequent cleaning, it is often desirable to spot treat and thereby remove any stains prior to dry-cleaning of an entire article. In order to prevent stains from re-appearing elsewhere on the garment being treated and avoid the seepage of liquids onto the user or surrounding surfaces, an absorbent stain receiving medium 102 is used in conjunction with a liquid pre-treatment solution 126. An absorbent stain receiver therefore comprises one of the components employed for pre-treating an article, and may optionally be used prior to dry-cleaning the entire article.

The absorbent stain receiving medium 102 for use with the dry-cleaning processes of the present invention typically comprises an absorbent pad of an appropriate sort. However, the material selected for use with the absorbent pad must be one that is suitable to address a number of criteria, given the manner in which it is used. A particularly well-known and highly effective method for spot-treating stains incorporates the introduction of a pre-treatment solution onto one side of a fabric, with a relatively more absorbent medium placed on the opposite side of the fabric. During application of the pre-treatment solution 126, the absorbent medium draws the stain-containing pre-treatment solution 126 through the fabric, and wicks it away from the fabric such that the stain is not redeposited on to the fabric. One criterion for an acceptable absorbent stain receiving medium 102, therefore, is that it must wet sufficiently quickly and be effective at drawing the pre-treatment solution 126 away from the item being treated.

Additional criteria for the absorbent stain receiving medium 102 or absorbent pad include: maintain the integrity of the absorbent pad through repeated use and/or rubbing without ripping, tearing or falling apart; non- or minimal linting, such that the absorbent pad does not introduce lint or fine particulate matter onto the article(s) being pre-treated; the surface of the absorbent pad should be smooth such that it does not interfere with the nap or surface texture of the article being pre-treated; provide a sufficient barrier to leakage of the pre-treatment solution 126 onto work surfaces or onto other regions of the article being cleaned to prevent undesirable contact with other articles or the user; provide a good “hand feel” such that use and placement of the absorbent pad is a pleasant experience; and not contain components which may transfer onto the article being cleaned.

A number of items were evaluated for possible use with the absorbent pad of the present invention. These included: paper toweling; commercially available diaper material; sponges; pads of polyester, rayon and the like; etc. Paper and cellulosic-based materials such as the above, however, were found to be too frangible and/or introduced too much lint onto the target articles to be desirable. Moreover, these items did not retain sufficient pre-treatment solution 126 to prevent further seepage onto surrounding fabrics or workspace. Pulp products were sufficiently absorbent, but ripped when rubbed. Various forms of polyethylene, polypropylene, polyester and rayon that were either air-laid or spun-bond were also evaluated. The problem with these materials was that they were either not very absorbent and did not wick the pre-treatment solution 126 away from the article being spot-treated, or they provided an insufficient moisture barrier to keep the pre-treatment solution 126 from leaking out onto the work surface.

In another series of tests, it was puzzling to discover that white, opaque or yellowing spots occasionally appeared on dry-cleaned articles that had previously been subject to pre-treatment processes. More thorough evaluation then revealed that the appearance of white spots was directly attributable to—and accompanied only the use of—certain absorbent pads in conjunction with pre-treatment solution 126 during the initial pre-treatment process. (In these instances, the application of heat during dryer treatment merely served to “set” the white spots and make them more noticeable.) Somewhat surprisingly, then, it was learned that the white spots were actually optical brighteners that had been transferred from the absorbent pad onto the article by the pre-treatment solution 126. Apparently, the pre-treatment solution 126 would wick the stain from the article onto the absorbent pad, but simultaneously introduce the brightener from the absorbent to the article being cleaned during pre-treatment! Consequently, prior art dry-cleaning kits that indicate that towels, absorbent cloths or paper toweling are acceptable for use as the stain-receiving article can potentially lead to deleterious results if the towels, cloths, etc., are laundered with cleaning products that contain optical brighteners or are manufactured with the optical brighteners to enhance their appearance for commercial sale. It is therefore preferred to use a stain-receiving article which does not incorporate optical brighteners at levels which exceed that which would result in a change of fluorescence—on the garment or fabric—greater than a Stensby Whiteness value of about 2.

One material that was found to provide especially acceptable stain-wicking and pre-treatment-wetting performance in addition to meeting the other criteria set forth above is a pulp/polypropylene meltblown (coform) absorbent pad commercially available from Kimberly-Clark. A particularly preferred coform absorbent pad has a basis weight of 190 grams per square meter (190 gsm). One or more laminates on the pad provide even better characteristics. According to one embodiment of the present invention, therefore, a coform absorbent pad features a moisture-resistant backing on one side of the pad. In an alternate embodiment of the present invention, a penetrable laminate that allows moisture to penetrate while preventing lint from being transferred from the pad to the article being cleaned is used on one side of the absorbent pad. According to a preferred embodiment of the present invention, the absorbent pad features both a moisture-resistant backing on one side of the pad and a moisture-penetrable laminate on the opposite side of the pad.

### Pre-Treatment Solution

In conjunction with dry-cleaning processes that are intended for home use, it is often desirable—although not imperative—to use a pre-treatment solution 126 for the spot removal of localized soils or stains on fabrics or garments to be cleaned. Typically, a pre-treatment solution is used in conjunction with an absorbent pad as described in the preceding section. However, as will be understood by those knowledgeable in the relevant art, the use of an absorbent pad is not necessarily required in conjunction with a pre-treatment solution 126, and such use is therefore optional. A number of different pre-treatment solution 126 compositions were evaluated for use in the dry-cleaning processes of the present invention, as will now be described further.

Technology with regards to pre-treatment solution predominately deals with their use prior to aqueous laundering or solvent dry-cleaning. Surprisingly, Applicants found that many such pre-treatment solutions were not suitable for use in the instant invention, for while they did not necessarily become manifest upon initial application or even after air-drying, the solutions did exhibit discoloration onto the underlying garment after treatment and subsequent introduction into a rotary dryer accompanied by high temperature drying. It is therefore a necessary criterion that an effective pre-treatment solution 126 be so formulated as to avoid discoloration during high temperature drying.

As stated above, in a preferred embodiment the fluid pre-treatment composition is non-thickened and comprises about 0.01-2.0% each of one or more anionic surfactant(s), about 0.01-5.0% each of one or more nonionic surfactant(s), about 0.01-2.0% amine oxide, about 0.0-1.0% preservative, about 0.01-4.0% sodium borate, and about 80.0-99.99% one or more fluid solvent(s).

In preferred embodiments, the total surfactants concentration is not greater than about 9.0% total weight. In more preferred embodiments, the total surfactants concentration is not greater than about 5.0%. In most preferred embodiments, the total surfactants concentration is not greater than about 5.0%.

Anionic and Nonionic Surfactants

The anionic surfactants may include a negatively charged water solubilizing group. Preferred groups are odium salts of sulfonated benzene, 1,1-oxybis, tetrapropylene derivatives are sold under the trademark Dowfax 2A1. Dowfax materials are from Dow Chemical Co. and are mixtures of sulfonated alkyldiphenyl ethers.

The nonionic surfactants may be selected from modified polysiloxanes, alkoxylated linear and branched alcohols, alkoxylated phenol ethers, glycosides, and the like. Trialkyl amine oxides, such as dimethyl, monododecyl amine oxide, and other surfactants often referred to as “semi-polar” nonionics, may also be employed. Alkyl polyoxyalkylene ether is sold under the trademark Surfonic JL-80X. Polyethylene glycol ethers including alkyloxypolyethyleneoxyethanol is sold under the trademark Tergitol 15-S-5 by Union Carbide as a nonionic surfactant.

Also preferred are modified polysiloxanes. The modified polysiloxane can be an alkoxylated dimethylsiloxane, such as those available from Byk Chemie, such as BYK-345. These agents have softening properties and will be included within the scope of the present invention.

The alkoxylated alcohols may include, for example, ethoxylated, and ethoxylated and propoxylated C₆₋₂₄ alcohols, with about 2-10 moles of ethylene oxide, or 1-10 and 1-10 moles of ethylene and propylene oxide per mole of alcohol, respectively. Exemplary surfactants are available from Shell Chemical under the trademarks Neodol and Alfonic, and from Huntsman Chemicals under the trademark Surfonic (e.g., Surfonic L12-6, a C₁₀₋₁₂ ethoxylated alcohol with 6 moles of ethylene oxide, and Surfonic L12-8, a C₁₀₋₁₂ ethoxylated alcohol with 8 moles of ethylene oxide, and others under the Surfonic label).

The alkoxylated phenol ethers may include, for example, octyl- and nonylphenol ethers, with varying degrees of alkoxylation, such as 1-10 moles of ethylene oxide per mole of phenol. The alkyl group may vary, for example, from C₆₋₁₆, with octyl- and nonyl chain lengths being readily available. Alkyl phenol ethoxylate is sold under the trademark Surfonic N-40. Various suitable products are available from Rohm & Haas under the trademark Triton, such as Triton N-57, N-101, N-111, X-45, X-100, X-102, from Mazer Chemicals under the trademark Macol, from GAF Corporation under the trademark Igepal, and from Huntsman under the trademark Surfonic.

The glycosides, particularly the alkyl polyglycosides, may also be used as a surfactant for purposes of the pre-treatment composition 126 of the present invention. These glycosides include those of the formula:
ROCₙH₂ₙO)_{y}(Z)ₓ
wherein R is a hydrophobic group (e.g., alkyl, aryl, alkylaryl etc., including branched or unbranched, saturated and unsaturated, and hydroxylated or alkoxylated members of the foregoing, among other possibilities) containing from about 6 to about 30 carbon atoms, preferably from about 8 to about 15 carbon atoms, and more preferably from about 9 to about 13 carbon atoms; n is a number from 2 to about 4, preferably 2 (thereby giving corresponding units such as ethylene, propylene and butylene oxide); y is a number having an average value of from 0 to about 12, preferably 0; Z is a moiety derived from a reducing saccharide containing 5 or 6 carbon atoms (e.g., a glucose, fructose, mannose, galactose, talose, gulose, allose, altrose, idose, arabinose, xylose, lyxose, or ribose unit, etc., but most preferably a glucose unit); and x is a number having an average value of from 1 to about 10, preferably from 1 to about 5, and more preferably from 1 to about 3.

It would be apparent that a number of variations with respect to the makeup of the glycosides are possible. For example, mixtures of saccharide moieties (Z) may be incorporated into polyglycosides. Also, the hydrophobic group (R) can be attached at the 2-, 3-, or 4-positions of a saccharide moiety rather than at the 1-position (thus giving, for example, a glucosyl as opposed to a glucoside). In addition, normally free hydroxyl groups of the saccharide moiety may be alkoxylated or polyalkoxylated. Further, the CₙH₂ₙO)_{y} group may include ethylene oxide and propylene oxide in random or block combinations, among a number of other possible variations.

An exemplary glycoside surfactant is APG 325n, which is manufactured by the Henkel Corporation. APG 325n is a nonionic alkyl polyglycoside in which R is a mixture of C₉, C₁₀ and C₁₁ chains in a weight ratio respectively of 20:40:40 (equivalent to an average of C_{10.2}), with x of 1.6, and an HLB of 13.1.

Compositions containing other surfactants may be more or less desirable as appropriate or equivalent for use in the color and fabric care composition of the present invention. It will be known to those skilled in the art that the use of any other surfactants, dispersing or emulsifying agents which are known and used presently, as well as those which are newly discovered or other known chemicals which are found to be useful as such or for such, will be included within the scope of the present invention.

A further semi-polar nonionic surfactant is alkylamidoalkylenedialkylamine oxide. Its structure is shown below: 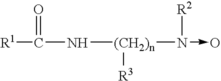
wherein R¹ is C₅₋₂₀ alkyl, R² and R³ are C₁₋₄ alkyl, R¹C—NH—(CH₂)ₙ— or —(CH₂)ₚ—OH, although R² and R³ do not have to be equal or the same substituent, and n is 1-5, preferably 3, and p is 1-6, preferably 2-3. Additionally, the surfactant could be ethoxylated (1-10 moles of EO/mole) or propoxylated (1-10 moles of PO/mole). This surfactant is available from various sources as a cocoamidopropyldimethyl amine oxide; it is sold by Lonza Chemical Company under the brand name Barlox C. Additional semi-polar surfactants may include phosphine oxides and sulfoxides.

Further examples on nonionics include Union Carbide's tri-methyl-nonyl alcohol ethoxylates with brand names Tergitol TMN-3 (2,6,8-trimethyl-4-nonyloxypolyethyleneoxyethanol) and Tergitol TMN-10. The TMN-series are “Tri-Methyl Nonanol ethoxylates”. The structures consist of a branched alkyl (synonomous with hydrocarbon) tail (the part that likes oil—hydrophobic or lipophilic) and a repeated ethylene oxide head (the part that likes water—hydrophilic or lipophobic). The branched alkyl tail makes the tail more hydrophobic than a unbranched or straight tail. The ethylene oxide portion is repeated units, termed ethoxylates. They like water and the longer the chain length, the more soluble the surfactant in water. Thus, alkyl EO-10 (TMN-10) with seven ethylene oxide groups is more soluble in water than alkyl EO-3 (TMN-3).

Other nonionics described in the following paragraphs are also suitable, for example the Tergitol linear ethoxylate sulfates which consist of a linear un-branched alkyl chain and pendant ethoxylate chain with a terminal sulfate group).

Amine Oxides

The amine oxides, referred to as mono-long chain, di-short chain, trialkyl amine oxides, have the general configuration: 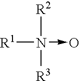
wherein R¹ is C₆₋₂₄ alkyl, and R² and R³ are both C₁₋₄ alkyl, or C₁₋₄ hydroxyalkyl, although R² and R³ do not have to be equal. These amine oxides can also be ethoxylated or propoxylated. The preferred amine oxide is lauryl amine oxide. The commercial sources for such amine oxides are Barlox 10, 12, 14 and 16 from Lonza Chemical Company, Varox by Witco and Ammonyx by Stepan Company. Ammonyx LO is another such amine oxide sold by Stepan Company.
Alkali Metal Borate

An additional additive which has been found to impart unique cleaning performance to the inventive pre-treatment composition is alkali metal borate, commonly referred to as borax. Borax, or, more accurately, di-alkali metal tetraborate n-hydrate (preferably, Na₂B₄O₇×nH₂O, where n=0-10, most preferably, 4, 5 or 10, although anhydrous borax is possible), is the preferred compound for use in the invention. The alkali metal counterion may be selected from sodium, potassium or lithium, or a combination thereof. Borax decahydrate is the most commonly found form of borax and is the compound assumed when one discusses borax. Borax pentahydrate is another preferred compound, and most preferred is borax tetrahydrate. Other boron-based compounds potentially suitable for use are disclosed in Kirk-Othmer, Encyclopedia of Chemical Technology, 3rd Ed., Vol. 4, pp. 67-109 (1978), said pages being incorporated herein by reference. Borax can be obtained from such vendors as U.S. Borax and North American Borax. Other potentially useful materials include boric acid (See, Kirk-Othmer, Encyclopedia Chemical Technology, 3rd Ed., Vol. 4, pp. 71-77 (1978), incorporated herein by reference). Boric acid has the structure H₃BO₃. Boric acid is available from such suppliers as Kerr-McGee Corporation. Polyborate, tetraboric acid, sodium metaborate and other forms of boron may also be appropriate alternative materials.

In the invention, it has been found that a critical amount of borate should be present in the pre-treatment composition. Preferably, the level of borate should not be greater than about 1.0%. More preferably, the level of borate should not be greater than about 0.8%. More preferably, the level of borate should not be greater than about 0.5%. Most preferably, the level of borate should be about 0.4%. These low levels have been found to enhance cleaning of the pretreated garments by assisting in the removal of stains, but, just as importantly, prevent the setting of certain problematic stains, such as mustard and spaghetti, on the treated fabric (see below).

Another important discovery which is included within the scope of the present invention is the complex relationship between pH, buffer capacity of the solution 126 and borate level. In general, an increased borate level can be effective in increasing pH levels, which clearly can have beneficial impacts on cleaning various stains including tomato based stains, coffee or tea, etc. however, at pH levels between about 10-11 and higher, distinctly deleterious effects can be seen in fabrics such as wool and silk. In a preferred embodiment, the pH is between about 7.0 and about 11.0. In another preferred embodiment, the pH is between about 8.0 and about 10.0. In a most preferred embodiment, the pH is about 9.0.

Preservatives

The category of preservatives provides anti-microbial, anti-bacterial and anti-fungal protection to the finished composition and its key components during processing and storage. These actives contribute to improved product stability and maintenance of activity, as well as prevention of undesirable microbial growth during extended storage.

Polyhexamethylenebiguanide is sold under the trademark Vantocil IB. Additional examples include Integra 44 (sodium hydroxymethylaminoacetate), Proxel GXL and Dowicil 75 antimicrobials.

The term “antibacterial agent” as used herein refers to materials which prevent or inhibit the growth of bacteria on an inanimate surface. Among the known antibacterial agents which are suitable for the present invention are phenolic and xylenol antibacterial agents. Two are particularly preferred: PCMX (para chlorometa xylenol) and Triclosan (2,4,4′-trichloro-2′-hydroxy diphenyl ether). These are normally solid at room temperature and have melting points of about 115 degree C. for PCMX and about 50 degree C. for Triclosan. Other useful antibacterial agents include 3,4,4′-trichloro carbanilide, DTBBP (2,t-butyl-4-cyclohexylphenol) and other suitable antibacterial compounds containing phenol groups. Also useful herein are oxidants such as sodium perborate, activated perborate, percarbonate and the like. Less preferred for the present invention are those antibacterial agents such as quaternary ammonium compounds which may be incompatible with certain detergent ingredients such as anionic surfactants.

Fluid Solvents

Since the pre-treatment solution 126 is an aqueous cleaner with relatively low levels of actives, the principal ingredient is water, or H₂O. Water should be present at a level of at least about 50%, more preferably at least about 70%, and most preferably, at least about 90%. It is most preferred that the percentage of water be about 80-99.99% water.

Distilled, deionized, reverse-osmosis, or industrial soft water is preferred so as not to contribute to formation of any residue or precipitates and to avoid the introduction of undesirable metal ions, organic compounds, etc.

Other solvents may optionally be used, in place of or in addition to water as the fluid carrier. It is generally a water soluble or dispersible organic solvent having a vapor pressure of at least 0.001 mm Hg at 25 degrees C. A key attribute is that is should volatilize rapidly, such that it volatilizes no more than 5 minutes after contact with a surface or open space, without leaving a residue. It is preferably selected from C₁₋₆ alkanols, C₁₋₆ diols, C₁₋₆ alkyl ethers of alkylene glycols and polyalkylene glycols, and mixtures thereof. The alkanol can be selected from methanol, ethanol, n-propanol, isopropanol, the various positional isomers of butanol, pentanol, and hexanol, and mixtures of the foregoing. It may also be possible to utilize in addition to, or in place of, said alkanols, the diols such as methylene, ethylene, propylene and butylene glycols, and mixtures thereof, and including polyalkylene glycols.

Straight or branched chain alkanol can be used in the invention. These are methanol, ethanol, n-propanol, isopropanol, and the various positional isomers of butanol, pentanol, and hexanol. One can also use a mixture of an alkanol with a glycol ether, in which case the ratio of the two components is between about 100:1 to 1:10. One can also use an alkylene glycol ether solvent in this invention. The alkylene glycol ether solvents can be used alone or in addition to the polar alkanol solvent. These can include, for example, monoalkylene glycol ethers such as ethylene glycol monopropyl ether, ethylene glycol mono-n-butyl ether, propylene glycol monopropyl ether, and propylene glycol mono-n-butyl ether, and polyalkyleneglycol ethers such as diethylene glycol monoethyl or monopropyl or monobutyl ether, di- or tri-polypropylene glycol monomethyl or monoethyl or monopropyl or monobutyl ether, etc., and mixtures thereof. Additionally, acetate and propionate esters of glycol ethers can be used. Suitable glycol ethers are diethylene glycol monobutyl ether, also known as 2-(2-butoxyethoxy) ethanol, sold as Butyl Carbitol by Union Carbide, ethylene glycol monobutyl ether, also known as butoxyethanol, sold as Butyl Cellusolve also by Union Carbide, and also sold by Dow Chemical Co., propylene glycol methyl monopropyl ether, available from a variety of sources, and propylene glycol methyl ether, sold by Dow as Dowanol PM. Another suitable alkylene glycol ether is propylene glycol t-butyl ether, which is commercially sold as Arcosolve PTB, by Arco Chemical Co. Dipropylene glycol n-butyl ether (DPNB) is also suitable.

### Studies

In a first series of studies, individual components were evaluated in aqueous solution to determine the most promising candidates with respect to stain removal and reduced ring residue formation. One substance that was investigated for use in a pre-treatment solution 126 was d-limonene, a fragrant substance which has both wetting and solvent characteristics. The materials that were evaluated in the form of 98% aqueous compositions are presented in Table I below.

TABLE I
Composition of Various 98% Aqueous Formulations

| Formulation | Pre-Treatment Active Ingredient(s) |
|---|---|
| A | C12-8 surfactant (a) |
| B | C24-12 surfactant (b) |
| C | C12 cocamine oxide (c) |
| D | d-Limonene (control) |
| E | iso-Propanol (IPA) |
| F | C24-4 surfactant (d) |
| G | Ethanol |
| H | Propanol |
| K | Prior art (control) |
| L | C24-7 surfactant (e) |

Footnotes to the table
(a) C12-8 refers to Surfonic ® L12-8, which is a C10-12 synthetic alcohol having 8 ethoxylate groups per molecule.
(b) C24-12 refers to Surfonic ® L24-12, which is a C12-14 synthetic alcohol having 12 ethoxylate groups per molecule.
(c) The C12 cocamine oxide is commercially available as Barlox ® 12, Aromox ® DMCD, Aromox ® DMC, etc.
(d) C24-4 refers to Surfonic ® L24-4, which is a C12-14 synthetic alcohol having 4 ethoxylate groups per molecule.
(e) C24-7 refers to Surfonic ® L24-7, which is a C12-14 synthetic alcohol having 7 ethoxylate groups per molecule.

Using the results from the above study, a second study was conducted using various combinations of the above ingredients. A first trial solution 126 that was prepared contained an amine oxide surfactant and d-limonene in water. A second solution 126 that contained d-limonene and Surfonic® C24-12 surfactant was also prepared. In a third trial, the Surfonic® C24-12 was replaced with an isopropanol/surfactant mixture containing a shorter carbon chain to help dissolve the d-limonene and reduce the total amount of surfactant used. All three of these compositions gave very good stain removal results, while the latter two compositions in particular performed well during freeze-thaw testing of solution 126 stabilities. However, each of the three compositions required large quantities of surfactant to solubilize the d-limonene, as it is relatively insoluble in water. One disadvantage associated with having too much surfactant in the pre-treatment solution 126 is that surfactant residues may linger on the article being pre-treated, thus resulting in the appearance of undesirable ring-shaped residues on the article after exposure to heat during the dry-cleaning process.

During the course of the above studies, it was realized that inclusion of the d-limonene, which required large amounts of surfactant for solubility purposes, also resulted in faster flow of the pre-treatment solution 126 through the applicator tip 124 being used to dispense the solution 126 onto the target article. Moreover, it was found that when used in conjunction with applicator bottles made of polyethylene, solution 126 containing d-limonene caused softening and widening of the dispensing applicator tip 124 being used to meter delivery of the pre-treatment. Fluorination of the polyethylene packaging components imparted sufficient resistance towards the d-limonene.

It was anticipated that for the purposes of the present invention, control of the dispensing rate of the pre-treatment composition could also be accomplished through adjustment of the pre-treatment formulation 126 itself. At this point, it should be noted that one product currently in the market requires a special pressure regulator baffle at the applicator tip in order to regulate delivery through the tip orifice for metered delivery of the pre-treatment solution 126. Without being bound by theory, Applicants speculate that the regulator baffle of this prior art device reduces the back pressure of the pre-treatment solution 126 in order to control the delivery flow rate.

A third series of experiments were then conducted in order to determine the best compositions for potential use in pre-treatment solution 126. The compositions were evaluated for: efficacy in removing spots and stains using a variety of stain sources; the extent to which any ring residues appeared; and the rate of dispensing through a reverse taper distal tip 124 applicator orifice of approximately 0.25 mm±0.08 mm (0.01″±0.003″). The compositions that were tested are indicated in Table II below.

TABLE II
Pre-Treatment Composition Series Tested for
Stain Removal, Ring Residue Reduction,
and Distal Tip Dispensing Rate

| Formulation | Pre-Treatment Actives | % Composition |
|---|---|---|
| Prototype I | d-Limonene | 0.05-1.0 |
| | C12 amine oxide | 0.05-0.5 |
| | Water | Balance (to approx. 98%) |
| Prototype II | C12 amine oxide | 0.05-0.15 |
| | C24-12 surfactant | 0.05-0.5 |
| | C12-8 surfactant | 0.1-2.4 |
| | iso-Propanol (IPA) | 0.25-2.0 |
| | Water | Balance (to approx. 98%) |

| | |
|---|---|
| Control | Commercial Product (thickened) |

The results obtained from testing several of the formulations indicated in Table II above are indicated in Table III below. The scale used for rating stain removal was from 1-3, with 1 being used to indicate the best stain removal, 2 indicates intermediate stain removal, while a 3 indicates the worst stain removal performance. The extent of any ring residue remaining after removal of a stain is visually rated from “+” to “Ø” to “−”. A rating of “+” indicates that virtually no detectable ring residue remained; a rating of “Ø” indicates an intermediate amount of ring residue; and a rating of “−” indicates a poor result in that a ring residue was clearly discemable.

TABLE III
Evaluation of Pre-Treatment Composition Performance
for Stain Removal, Reduction of Ring Residue and
Controlled Delivery at Distal Tip Applicator

| | Formulation: | | | | | |
|---|---|---|---|---|---|---|
| | Prototype I | | Prototype II | | Control | |
| Stain: | Stain | Ring | Stain | Ring | Stain | Ring |
| Coffee | 2 | Ø | 2 | Ø | 2 | Ø |
| Tea | 1 | Ø | 1 | Ø | 1 | Ø |
| Red wine | 1 | + | 1 | + | 1 | + |
| Spaghetti sauce | 1 | + | 1 | + | 1 | + |
| Gravy | 1 | + | 1 | + | 2 | Ø |
| Ballpoint ink | 3 | Ø | 3 | (a) | 2 | − |
| Lipstick | 3 | Ø | 3 | (a) | 2 | − |
| Sebum 1 | + | 1 | Ø | 2 | Ø | |
| Mustard | 1 | Ø | 1 | + | 2 | Ø |
| Chocolate sauce | 1 | + | 1 | + | 2 | Ø |

Notes to the table
(a) Not applicable: stain too heavily loaded to discern a significant difference.
Rating Scales:
Stain Removal (“Stain”): 1 = best 2 = intermediate 3 = worst
Reduced Ring Residue (“Ring”): + = best Ø intermediate − = worst

As may be seen from the results shown in Table III above, overall, Prototypes I and II of the present invention performed at least as well as, and in some cases evidenced clear improvements in stain removal performance over, the commercially available product when used in conjunction with the absorbent pad. Adequacy of slow, metered flow rate was also evidenced by each of the Prototype compositions of the present invention indicated in Table III. Again, it is worthy of mention that the formulations 126 of the present invention demonstrated that such compositions can be delivered at a slow, metered rate, without the need for a flow restricting or pressure regulating modification to the applicator distal tip 124. The dispensers 120 and dispensing tips 124 that were used are commercially available polyvinyl chloride or polyethylene stock items that were used without any further modification whatsoever. The distal tip 124 is available from Polyseal Company as 20/572 Round Control tip, with diameter 0.01″.

### Preferred Formulas

The following is a preferred embodiment of the pretreatment solution 126 of the present invention:

| Ingredient | Active Wt. % |
|---|---|
| Dowfax 2A1 | 0.14% |
| SurfonicLF-40 | 0.05% |
| Surfonic N-40 | 0.20% |
| Surfonic JL-80X | 0.05% |
| Surfonic 24-4 | 0.03% |
| Ammonyx LO | 0.05% |
| Vantocil | 0.10% |
| Tergitol(TMN-3) | 0.20% |
| Borax | 0.31% |
| DI Water | 98.90% |

The following is another preferred embodiment of the pretreatment solution 126 of the present invention:

| Ingredient | Active Wt. % |
|---|---|
| Dowfax 2A1 | 0.07% |
| Tergitol 15-S-5 | 0.10% |
| Ammonyx LO | 0.12% |
| Integra 44 | 0.10% |
| Borax | 0.40% |
| DI Water | 98.90% |

In the course of experimentation, surprising results were obtained. The following formula “set in” spaghetti and mustard stains:

| Ingredient | Active Wt. % |
|---|---|
| Dowfax | 0.05% |
| Surfonic 24-9 | 0.05% |
| Ammonyx LO | 0.05% |
| Surfonic 24-12 | 0.05% |
| Borax | 1.00% |
| DI Water | 98.80% |

The following formulas with less borax performed better:

| Ingredient | Active Wt. % |
|---|---|
| Dowfax | 0.05% |
| Surfonic 24-9 | 0.05% |
| Ammonyx LO | 0.05% |
| Surfonic 24-12 | 0.05% |
| Borax | 0.75% |
| DI Water | 98.80% |
| Dowfax 2A1 | 0.10% |
| Surfonic LF-40 | 0.50% |
| Surfonic JL-80X | 0.10% |
| Borax | 0.50% |
| DI Water | 98.80% |

Interestingly and furthermore, the foregoing studies also surprisingly revealed that it was not an increase in the use of surfactant concentration in the pre-treatment cleaning solution 126, but rather a decrease in surfactant concentration that exhibited improved stain cleaning ability. In fact, a definite synergistic effect was noted in that reduced ring residues accompanied the reduction of surfactant levels!

### Activator Cloth

One of the principal components used in dry-cleaning is a medium capable of delivering a refreshing or activating composition to the article or articles being refreshed or dry-cleaned. In the present invention, the vehicle that is typically used to accomplish this task is alternately referred to as a refreshing cloth, fresh care cloth, activator sheet or an “activator cloth 104.” The latter term will be used to encompass all the foregoing terminology herein. The activator cloth 104 is typically a binderless hydroentangled absorbent material, especially a material which is formulated from a blend of cellulosic, rayon, polyester and optional bicomponent fibers. Such materials are available from The Dexter Corporation, Non-Wovens Division, as HYDRASPUN®, especially Grade 10244 or from Kimberly-Clark.

While theoretically any activator cloth 104 may be used, the parameters that are selected for the activator cloth 104 will be such that it delivers a pre-determined amount of dry-cleaning activator solution 106 during the cleaning/refreshing process. Thus, delivery of the activator solution 106 may be a function of the total loading of the activator cloth 104, surface area, pore size, wicking or dispersing rate, temperature, affinity of the activator solution 106 for the cloth 104, etc.

### Activator Solution

A key aspect of the dry-cleaning process according to the present invention involves the use of a suitable solution 106 for the cleaning and/or refreshing of fabrics or garments. It is to be understood that the term “activator solution 106” as used herein thus refers to a predominately aqueous mixture that is used for the cleaning and/or refreshing of fabrics or garments. Surprisingly, it was learned during the course of experimentation and evaluation of various dry-cleaning techniques and cleaning compositions that optimal results were achieved where contact with water was minimized, and where either no surfactants or only a minimal amount of surfactants were used. The reasons for this may be postulated as follows. Steam or water vapor can help relax fibers and thus reduce the amount of wrinkling ultimately observed in a garment or other fabric article after the article has been dried. More thorough wetting, as with a higher level of water penetration, however, when coupled with heating, effectively solvates the fibers resulting in softening of the configuration of the fiber, such that new, relaxed and often random configurations result. This latter situation is not preferred during cooling and drying (mentioned above and discussed more fully below), as the random settings and disoriented fibers which accompany these higher wetting and humidification conditions most commonly becomes manifest as wrinkles.

An important aspect of the activator solution 106 is its ability to assist with the partition of the soil or stain from the textile article to be cleaned. The activator solution 106, upon vaporization and permeation of the textile article to be cleaned induces or causes release, separation, removal or other form of partitioning of the soil, debris or stain from the article to be cleaned. As the soil partitions from the article to be cleaned, it migrates to the stain absorbing medium 102 within the containment system 110. Nevertheless, without being bound by theory and in the interest of clarity, it will be understood that in the present invention, the activator solution 106 acts by partitioning or separating the soil from the textile article to be cleaned.

Interestingly, in the course of the present invention, Applicants determined that although surfactants are highly desirable in conventional laundering operations, their use in conjunction with dry-cleaning techniques can actually be deleterious. Surfactants tend to function as a wetting agent and promote the wettability of garments and fabric articles with which they come into contact. Once the surface of a fabric is wetted, aqueous solutions can then readily penetrate into the bulk of the fabric. Thus aqueous solutions, especially in large amounts, are to be avoided, whereas steam or water vapor during the dry-cleaning or refreshing process is actually desirable.

As discussed above, the greater the water penetration and content, the greater the tendency for articles being cleaned or refreshed to wrinkle upon heat treatment. It is therefore desirable to minimize the amount of direct contact with water for articles being dry-cleaned or refreshed to the greatest extent possible. By eliminating surfactants from the activator solution 106 of the present invention entirely, Applicants have therefore eliminated a major contributing factor—if not a primary source—of wrinkles and setting up of those wrinkles upon drying. Accordingly, the components intended for dry-cleaning and/or refreshing according to the present invention contain no surfactants whatsoever, and function optimally with water that is in the vapor phase.

An added benefit of having no surfactant in the activator solution 106 of the present invention concerns the formation of spot residues. As mentioned previously in the discussion on pre-treatment solution 126, one disadvantage associated with the use of surfactants is the tendency of surfactant residues to form on the article being treated, which can thus result in the appearance of undesirable ring-shaped residues on an article after exposure to heat during a dry-cleaning process. Note that the use of surfactants in conventional laundering pre-treatment solutions is not problematic, however, as a sufficient quantity of water is employed to dissolve and thereafter rinse away excess surfactants during subsequent laundering. Accordingly, surfactant residues are typically not observed on conventionally laundered items. Dry-cleaning processes do not use the same levels of water as used in conventional laundering processes, and thus it will be understood that in general, levels of surfactants in dry-cleaning processes should be low.

The use of surfactants in activator solutions intended for use with dry-cleaning processes is therefore undesirable from at least two standpoints. First, surfactants lead to better wetting of garments being cleaned and/or refreshed, which can result in greater wrinkling after heat processing. Second, as surfactants are not volatile, they tend to leave residues behind on the articles with which they come into contact where there is insufficient water to dissolve and wash the surfactant away. For all of the foregoing reasons, therefore, Applicants determined that a non-surfactant containing activator solution 106 would be the most desirable for use with the processes of the present invention.

In light of the above discussions, and following a series of evaluations, Applicants determined that the best embodiment of a activator solution 106 for use with dry-cleaning processes according to the present invention is one that comprises:
(a) a volatile solvent;
(b) a fragrance source and
(c) balance, water.
   The above activator solution 106 may also comprise:
(d) optionally, at least one preservative; and
(e) optionally at least one quality control aid.

The reason for the preservative in the above formulations is that the vehicle for delivery of the activator solution 106 is the activator cloth 104 mentioned above. The activator cloth 104 is immersed in, exposed to, coated or treated with, or in some appropriate manner made to deliver up the activator solution 106 for use with the dry-cleaning processes of the present invention. The activator cloth 104-activator solution 106 combination is packaged within a suitable containment device 108 that reduces or prevents the evaporation of water from the activator solution 106 during storage and handling, yet provides the appropriate usage dose of the activator solution 106 for the dry-cleaning process. Use of a preservative is therefore advantageous to avoid microbial contamination of activator solution 106 actives to the non-commercial dry-cleaning process.

Typically, the volatile solvent that is used with the activator solution 106 of the present invention comprises an alcohol. Alcohols that are suitable for use with the present invention include mono- or di-hydric alcohols that have a boiling point less than about 150° C. (approx. 302° F.). Levels of the solvent that are appropriate for use in the present invention are approximately 0.1 to 10.0%, preferably about 0.2 to 1.5%, and most preferably about 0.3 to 1.3%. The levels of fragrance that have been found to be appropriate for use with the cleaning compositions of the present invention are approximately 0.1 to 1.0%, preferably 0.2 to 0.9%, and most preferably about 0.3 to 0.8%. The balance is water.

Optional ingredients which may be included in the activator solution 106 of the present invention include a preservative. Preservatives which are suitable for use with the present invention include benzoates, citrates and sorbates. Potassium citrate is a preferred embodiment according to one embodiment of the present invention. When present, the preservative is used at levels of less than 2.0%, preferably less than 0.4%, and most preferably less than about 0.3%. In one formulation according to the present invention, approximately 0.1% of potassium citrate is used. An optional ingredient also suitable for use with the activator solution 106 of the present invention is a quality control aid. A suitable quality control aid includes ethylenediaminetetraacetic acid, EDTA, most preferably the tetrasodium salt thereof.

Another important aspect of the activator solution 106 according to the present invention is the quantity of material that is used. As discussed previously, the presence of too much water during the dry-cleaning/fabric refreshing process can be deleterious in terms of the amount of wrinkling that results from exposure to too much water and concomitant reorientation of fiber microstructure. Applicants have surprisingly discovered that the elimination of surfactants from the activator solution 106 of the present invention has enabled them to correspondingly reduce the total amount of liquids used. Thus, whereas existing prior art non-commercial dry-cleaning kits feature activator cloths that deliver up on the order of approximately 28 grams of activator solution, Applicants have determined that less wrinkling and reduced ring residues can be achieved with smaller volumes of activator solution 106. Activator cloths 104 according to the present invention therefore contain less than about 28 grams of activator solution 106, preferably less than about 24 grams of activator solution 106, and most preferably less than about 20 grams of activator solution 106. According to a most preferred embodiment of the present invention, activator cloths 104 are loaded with about 18-20 grams of activator solution 106 or less. Note that the prior art loading of approximately 28 grams of activator solution represents nearly a 50% increase over the amount used in the present invention. An important aspect of the present invention is the ability to utilize an activator or other absorbent cloth 104 loaded with a minimal amount of activator fluid 106, in particular, as little as half that used in the prior art.

Through a series of studies, it was found that the best performance of refreshing and cleaning with minimal wrinkling was only partially dependent on the characteristics of venting from the bag 110. In fact, the most preferred embodiment provided a minimum of activator solution 106 for refreshing and cleaning while maintaining a critical humidity to the contained environment. For example, it was found that a heavily-loaded activator cloth 104 used in conjunction with a bag 110 which vents, for example, 40-90% of its generated vapor still results in a very damp activator cloth 104, which can spot the garments and induce significant wrinkling. Likewise, a very lightly-loaded activator cloth 104 used in conjunction with a bag 110 which vents, for example, 40-90% of its generated vapor results in an environment in the bag 110 with little residual humidity, which subsequently also results in significant wrinkling. In a preferred embodiment, the containment bag 110 achieves about 5-35% ventilation of its generated vapors. Reducing the generated vapors is an objective and advantage of the present invention. This is because generated vapors may contain compounds which are corrosive to the dryer or articles being cleaned, and the vapors may be harmful to the environment, workers or users of the articles being cleaned,

A few comments on the flow rate and level of addition of the activator solution 106 are in order here. Through a series of studies, it was found that the best performance of the activator solution 106 in conjunction with a non-commercial dry-cleaning process is one which provides a slow rate of application of the activator solution 106 to the article being cleaned and/or refreshed, and simultaneously one that delivers a minimal amount of activator solution 106 to the target article. In fact, it was surprisingly discovered that the original loading (OL) of the activator solution 106 onto the target article is immediately correlatable and directly proportional to the amount of wrinkling observed in the article at the end of the dry-cleaning/refreshing process! Thus, where wrinkling is evaluated by the term WL, for wrinkle level, the relationship between original loading of activator solution 106 and wrinkle level observed at the end of the entire dry-cleaning process may be represented by:
WL=f(OL, FW, VE, TC) (1)

where: WL=wrinkle level;
OL=original loading of the activator composition;
FW=fabric wettability;
VE=vapor equilibrium; and
TC=a temperature-dependent correction-factor.

The remaining terms in Equation (1), i.e., FW (fabric wettability), VE (vapor equilibrium), and TC (a temperature-dependent correction factor) will be discussed more fully in conjunction with the discussions which follow below.

### Containment Bag and Closure

The containment bag 110 provides the environment in which fabric cleaning and refreshing occurs according to the dry-cleaning process of the present invention. As previously mentioned above, the containment bag 110 is contemplated for use in conjunction with an appropriate heat source, which typically comprises use of a rotary dryer. Thus, in addition to heat tolerance, it is important that the bag 110 be of a design which provides an appropriate spatial region in which the garments are to be refreshened; sufficient volume in which to create a vaporous headspace; and control the flow of vapors into and out of the bag 110. Thus, where no resistance to vapor flow is provided, the volatilized solvents of the activator solution 106 prematurely leave the containment bag 110 without effectively acting on the garment to be refreshened. Conversely, where there is too much resistance to vapor transmission, malodors which have been removed from the garment remain trapped within the bag 110 and settle back onto the article(s) at the end of the drying cycle.

The vapor transmission, or venting out of the bag 110, is controlled by the closure 112 provided on the bag 110. Suitable closure or fastening means 112 may be any useful fastening means 112 known to the art including, but not limited to one or more of the following: zippers; hook-and-loop type fasteners (as in Velcro®); buttons; clips; pins; snaps; adhesive strips or tape; resealable mated sealing strips, commonly known as Zip-Lock® type closures; and etc.

The containment bag 110 used herein is constructed of one or more polymeric films which will withstand temperatures reasonably anticipated in non-commercial dryer environments. One example of non-commercial dryers are those found in most homes. While home dryers are typically designed to operate in a hot cycle range of 70-90° C. (approx. 158-194° F.), air temperatures as high as 150° C. (approximately 302° F.) have been recorded. Thus, the containment bag 110 according to the present invention must remain intact and functional at temperatures as high as 150° C. (approx. 302° F.) without loss of structural integrity, i.e., melting or shredding, etc. Polypropylenes, polyesters, polybutylenes and polyamides are capable of withstanding these higher temperatures.

Containment bags 110 used for non-commercial dry-cleaning applications, as in the present invention, must also be capable of being used more than once. One prior art containment bag currently on the market uses a Nylon 6-12 material which becomes brittle and loses strength on repeated use. To avoid the risk of containment bag 110 failure after repeated use, it is thus important to select a polymer which will retain its resiliency. It has been found that containment bags 110 that are constructed of polypropylene, and more preferably polypropylene blended with a minor—less than 10% by weight—quantity of polyethylene, is highly desirable. Such polyethylene-polypropylene blends were found to both remain resilient after repeated use, and survive dryer air temperatures as high as 150° C. (approx. 302° F.). It was also surprising to find that the melting point of the polyethylene-doped polypropylene actually exhibited a higher heat resistance than either homopolymer alone.

The dimensions of the containment bag 110 according to the present invention can vary depending on the application. Smaller or fewer garments may require a much smaller bag 110, while larger garments, such as overcoats, or more numerous articles, would require a larger bag 110. Typically, the containment bag 110 volume will be about 1,000 to 25,000 cm³. A 65 cm×76 cm (approx. 25.5″×30″) containment bag 110 with an appropriate closure can provide the requisite enclosed volume for a preferred embodiment, while larger or smaller containment bags 110 will also be included within the scope of this invention. While the containment bags 110 can be of varying thicknesses, a preferred thickness is approximately about 0.064 mm±10% (2.5 mil±10%).

### Kit

It will be understood based on the foregoing that the present mvention is intended for use in homes. Household clothes driers and fabric driers will be especially useful in this regard. The present invention is also adapted for use in commercial establishments, including restaurants, beauty salons, industrial applications, etc. Therefore, it will be particulary useful to provide the following items together in a kit 100:
1. Absorbent stain removal medium 102, for absorbing the stain partitioned from the article to be cleaned;
2. Activator solution 106, for partitioning the stain from the article to be cleaned, the activator solution 106 comprising essentially volatile solvent, optional fragrance and the balance water;
3. Activator cloth 104 or other substrate, with a predetermined volume of the activator solution 106 loaded thereon; and
4. A containment system 110 for containing the textile article to be cleaned, the absorbent stain removal medium 102, and the activator cloth 104, all within the dryer, whereby the textile article to be cleaned, the absorbent stain removal medium 102, and the activator cloth 104 are maintained in an operative proximity during the cleaning process.
   Optionally, the kit 100 also comprises:
5. Pre-treatment stain formula 126 for pre-treating spots prior to cleaning, the formula 126 preferably being non-thickened; and
6. Operative dispenser means 120 for dispensing controlled volumes of the pre-treatment stain formula 126 onto the textile article to be cleaned.

### Process/Method of Use

In a preferred embodiment of the present invention, a process for the dry-cleaning of a garment or other textile article comprises:
(a) optionally pre-treating the textile containing a localized area of stain by subjecting it to a fluid pre-treatment composition 126 in combination with an absorbent stain receiving medium 102; and
(b) heat treating the textile that has been optionally pre-treated according to step (a) together with an activator cloth 104 containing an activator solution 106 into a flexible, sealable containment means 110.

In use, it will be understood that dispensing a controlled amount of pre-treatment solution 126 onto a stain or spot on an article of clothing can be performed in at least two different ways. Therefore, in a preferred embodiment of the present invention, the method comprises dispensing a controlled volume of the pre-treatment fluid 126 directly onto the spot or stain to be removed, and optionally utilizing the absorbent stain receiving medium 102 on the back side of the article. However, it has surprisingly been found that in a preferred embodiment, the method comprises dispensing a controlled volume of the pre-treatment fluid 126 onto the article on the reverse side of the stain, directly opposite the stain or spot, and by employing the absorbent stain receiving medium 102 directly in contact with the satin or spot on the spot or stain side of the article.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

1. A fluid pre-treatment composition for use in dry-cleaning textile article processes comprising about 0.01-5.0% each of one or more surfactants selected from the group consisting of anionic surfactants and nonionic surfactants, about 0.01-2.0% amine oxide, about 0.0-1.0% preservative, about 0.01-4.0% alkali metal borate, and about 50.0-99.99% fluid solvent.

2. A fluid pre-treatment composition for use in dry-cleaning textile article processes comprising about 0.01-2.0% each of one or more anionic surfactant(s), about 0.01-5.0% each of one or more nonionic surfactant(s), about 0.01-2.0% amine oxide, about 0.0-1.0% preservative, about 0.01-4.0% alkali metal borate, and about 80.0-99.99% one or more fluid solvent(s).

3. The fluid pre-treatment composition of claim 2 in which the 0.01-2.0% each one or more anionic surfactant(s) comprises derivatives or mixtures of one or more sulfonated alkyldiphenyl ethers.

4. The fluid pre-treatment composition of claim 11 in which the 0.01-2.0% each of one or more anionic surfactant(s) comprises sodium salts of sulfonated benzene, 1,1-oxybis, tetrapropylene derivatives.

5. The fluid pre-treatment composition of claim 2 comprising 0.02-1.0% each of one or more anionic surfactant(s).

6. The fluid pre-treatment composition of claim 2 comprising 0.03-0.7% each of one or more anionic surfactant(s).

7. The fluid pre-treatment composition of claim 2 in which the 0.01-5.0% each of one or more nonionic surfactant(s) comprises derivatives or mixtures of one or more polyethylene glycol ethers including alkyloxypolyethyleneoxyethanol, ethoxylated, and ethoxylated and propoxylated C₆₋₂₄ alcohols, with about 2-10 moles of ethylene oxide, or 1-10 and 1-10 moles of ethylene and propylene oxide per mole of alcohol, respectively, other ethoxylated and propoxylated linear short chain and long chain, straight and branched chain alcohols and ethers, alkoxylated phenol ethers including octyl- and nonylphenol ethers, with varying degrees of alkoxylation including 1-10 moles of ethylene oxide per mole of phenol, the alkyl group varying from C₆₋₁₆, with octyl- and nonyl chain lengths, and alkyl polyoxyalkylene ether.

8. The fluid pre-treatment composition of claim 2 comprising 0.02-1.0% each of one or more nonionic surfactant(s).

9. The fluid pre-treatment composition of claim 2 comprising 0.03-0.1% each of one or more nonionic surfactant(s).

10. The fluid pre-treatment composition of claim 2 in which the about 0.01-2.0% amine oxide comprises one or more of mono-long chain, di-short chain, trialkyl amine oxides, and lauryl amine oxide.

11. The fluid pre-treatment composition of claim 2 comprising about 0.02-1.0% amine oxide.

12. The fluid pre-treatment composition of claim 2 comprising about 0.03-0.5% amine oxide.

13. The fluid pre-treatment composition of claim 2 in which the about 0.0-1.0% preservative comprises one or more of anti-microbial, anti-bacterial and anti-fungal agents, polyhexamethylenebiguanide, sodium hydroxymethylaminoacetate, phenolic and xylenol agents including para chlorometa xylenol and 2,4,4′-trichloro-2′-hydroxy diphenyl ether, 3,4,4′-trichloro carbanilide, 2,t-butyl-4-cyclohexylphenol, sodium perborate, activated perborate, percarbonate, and quatemary ammonium compounds.

14. The fluid pre-treatment composition of claim 2 comprising about 0.01-0.5% preservative.

15. The fluid pre-treatment composition of claim 2 in which the about 80.0-99.99% one or more fluid solvent(s) comprises one or more of water, distilled water, C₁₋₁₀ alkanols, C₂₋₁₀ diols, C₃₋₂₄ glycol ethers, and mixtures thereof.

16. The fluid pre-treatment composition of claim 2 comprising not more than about 1.0% borate.

17. The fluid pre-treatment composition of claim 2 comprising not more than about 0.8% borate.

18. The fluid pre-treatment composition of claim 2 comprising not more than about 0.5% borate.

19. The fluid pre-treatment composition of claim 2 comprising about 0.4% borate.

20. The fluid pre-treatment composition of claim 2 in which the pH is not higher than about 10-11.

21. The fluid pre-treatment composition of claim 2 in which the pH is between about 7 and about 11.

22. The fluid pre-treatment composition of claim 2 in which the pH is between about 8 and about 10.

23. The fluid pre-treatment composition of claim 2 in which the pH is about 9.0.

24. A dispensable fluid pre-treatment composition for use in dry-cleaning of textile article processes comprising:
about 0.01-5.0% each of one or more surfactants selected from the group consisting of anionic surfactants and nonionic surfactants;
about 0.01-2.0% amine oxide;
about 0.0-1.0% preservative;
about 0.01-4.0% alkali metal borate;
about 50.0-99.99% fluid solvent; and
dispenser for controllably dispensing the composition onto a textile article.

25. A controllably releasable fluid pre-treatment composition in a dispenser for use in dry-cleaning of textile article processes comprising about 0.01-5.0% each of one or more surfactants selected from the group consisting of anionic surfactants and nonionic surfactants, about 0.01-2.0% amine oxide, about 0.0-1.0% preservative, about 0.01-4.0% alkali metal borate, and about 50.0-99.99% fluid solvent, the composition contained within a dispenser for controllably dispensing the composition onto a textile article.

26. The contained composition of claim 25 in which the dispenser is a plastic bottle.

27. The contained composition of claim 25 in which the dispenser comprises an eye dropper

28. The contained composition of claim 25 in which the dispenser is a pad.
